(19) United States
(12) Patent Application Publication
(10) Pub. No.: US 2011/0149215 A1
(43) Pub. Date: Jun. 23, 2011

(54) Color filter substrate and liquid crystal display device

(75) Inventors: Mie Shimizu, Tokyo (JP); Takeshi Ikeda, Tokyo (JP); Hidesato Hagiwara, Tokyo (JP); Koichi Minato, Tokyo (JP)

(73) Assignee: TOPPAN PRINTING CO., LTD., Tokyo (JP)

(21) Appl. No.: 12/926,742

(22) Filed: Dec. 7, 2010

(30) Foreign Application Priority Data
Dec. 22, 2009 (JP) 2009-291416

(51) Int. Cl. G02F 1/1335; G02B 5/22

(52) U.S. Cl. 349/106; 359/891

(57) ABSTRACT

Disclosed is a color filter substrate provided with a transparent substrate, and a plurality of color pixels including a green pixel and formed on the transparent substrate. The green pixel contains halogenated zinc phthalocyanine-based green pigment and at least one kind of yellow pigment and satisfies prescribed three conditions, and absolute value of retardation in thickness direction (Rth) of the green pixel is confined to no more than 2 nm.

### CROSS-REFERENCE TO RELATED APPLICATIONS

This application is based upon and claims the benefit of priority from prior Japanese Patent Application No. 2009-291416, filed Dec. 22, 2009, the entire contents of which are incorporated herein by reference.

### BACKGROUND OF THE INVENTION

1. Field of the Invention

This invention relates to a color filter substrate to be employed in a liquid crystal display device, and to a liquid crystal display device which is provided with this color filter substrate.

2. Description of the Related Art

In recent years, slim display devices such as a liquid crystal display device are increasingly demanded to enhance the picture image and power-saving thereof and to lower the manufacturing cost thereof. Especially, in the case of an oversize television or a high picture quality monitor, where the display contrast thereof is not less than 2000, they are now demanded to exhibit not only a high front contrast but also a very high level of display quality with respect to viewing angle characteristics including oblique viewing.

In the case of the color filter, the filter is required to be formed with color pixels exhibiting a small retardation in order to avoid the color tarnishing of the display in the darkened or OFF state at a wide viewing angle. Even if optical designing is elaborated on a liquid crystal display device as a whole, a small degree of retardation (for example, +10 nm or so) is inevitably left uncorrected in the color layers of color filter, thereby more likely deteriorating the oblique visibility of the liquid crystal display device. Especially in the case of green pixel which is high in luminosity factor to the eyes of viewers, the magnitude of retardation may become a problem.

In view of the problem described above, there has been tried to reduce the quantity of retardation that the color filter may exhibit, wherein a high polymer having a planar structural group on its side chain is introduced into a color layer, or a birefringence-reducing particles having a birefringence which is opposite in sign to that of the high polymer is introduced into the color layer (see for example, JP-A 2000-136253 and JP-A 2000-187114).

Further, there has been proposed an idea to incorporate a retardation-adjusting agent in the color layers of color filter, thus enabling each of subpixels to have a different retardation, thereby making it possible to enable the viewing angle compensation of the display in the darkened or OFF state in a liquid crystal display device to be effected in the wavelength of almost all visible light range without necessitating the provision of a polymer type liquid crystal layer in addition to the color layers or without necessitating the change in thickness in each of subpixels (see for example, JP-A 2008-40486 and JP-A 2008-145868).

The methods described above however are accompanied with a problem that when it is tried to control the retardation of the pixels, various characteristics including the physical properties of the color filter are caused to change. The reason is that when a side chain having a planar structural group is introduced into a high polymer acting as a pigment carrier in a color film, the density, mechanical strength and chemical resistance of the color film may be caused to change or the etching characteristics of the color film may be caused to change in a system of creating a pattern by means of photolithography, thereby raising various problems in the manufacture of the color filter. In a method of additionally incorporating birefringence-reducing particles also, since a material which causes degradation of the strength of film, mechanical strength, chemical resistance, adhesion of the thin film may be deteriorated.

It has been found out by the present inventors that, if it is desired to facilitate or optimize the design of a liquid crystal panel and other components, it is more preferable to minimize the retardation in thickness direction Rth in all the color pixels of the color filter. Especially, in the case of a green pixel which is very important in terms of luminosity factor, it has been considered difficult to minimize the retardation while securing not only the optimal color as green but also high luminosity of green.

### BRIEF SUMMARY OF THE INVENTION

Objects of the present invention are to provide a color filter substrate having a green pixel of small retardation while securing not only optimal green but also high luminosity of green and to provide a liquid crystal display device having the aforementioned color filter substrate incorporated therein and exhibiting high contrast and excellent oblique visibility when displaying the darkened or OFF state.

According to a first aspect of the present invention, there is provided a color filter substrate comprising a transparent substrate, and a plurality of color pixels including a green pixel and formed on the transparent substrate, wherein the green pixel contains halogenated zinc phthalocyanine-based green pigment and at least one kind of yellow pigment and satisfies three conditions (a), (b) and (c) described below, and absolute value of retardation in thickness direction (Rth) of the green pixel which is represented by the following equation (2) is confined to no more than 2 nm.

(a) Chromaticity (x, y) based on the C-light source of the green pixel is regulated so as to fall within a region encircled by straight lines connecting four points of: (0.255, 0.625), (0.275, 0.580), (0.325, 0.580) and (0.305, 0.625);

(b) When chromaticity of the green pixel based on C-light source is set to y=0.600, luminosity Y is not less than 57.0; and

(c) Absolute value of a sum of products of a birefringence of each of pigments (A, B, - - - ) constituting the green pixel and weight ratio of each of pigments satisfies following formula (1):

|{(Δn of pigment A)×(weight ratio of pigment A)}+{(Δn of pigment B)×(weight ratio of pigment B)}+ - - - |≦0.006 (1):

wherein Δn is a birefringence obtained by subtracting refractive index in thickness direction n_{Z} of a color film formed of a pigment sample from average in-plane refractive index n_{XY} of a color film formed of a pigment sample.

Rth={(Nx+Ny)/2−Nz}×d (2)

wherein Nx is a refractive index in x-direction in a plane of the green pixel; Ny is a refractive index in y-direction in a plane of the green pixel; Nz is a refractive index in thickness direction of the green pixel, Nx being defined as a slow axis represented by Nx≧Ny; and d is a thickness [nm] of the green pixel.

According to a second aspect of the present invention, there is provided a liquid crystal display device which is provided with the color filter substrate according to the first aspect of the present invention.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view schematically illustrating the color filter according to a first embodiment of the present invention;

FIG. 2 is a cross-sectional view schematically illustrating one example of a liquid crystal display device according to a second embodiment of the present invention;

FIG. 3 is a graph illustrating the results measured of chromaticity of a coated color film according to one example; and

FIG. 4 is a graph illustrating the results measured of chromaticity of a coated color film according to one comparative example.

### DETAILED DESCRIPTION OF THE INVENTION

Next, various embodiments of the present invention will be explained.

In the explanation of various embodiments of the present invention, the values of optical properties are defined as follows in the present specification.

n_{XY}: Average of refractive index in the case where the direction of vibration of light is parallel with the surface of thin film;

n_{Z}: Refractive index in the case where the direction of vibration of light is perpendicular to the surface of thin film;

D: Film thickness of thin film;

Birefringence Δn=n_{XY}−n_{Z}; and

Retardation in thickness direction Rth=Δn×d.

With respect to refractive index, birefringence and retardation in thickness direction, the measured values employed therein are obtained at a wavelength of the peak of transmitted light of color pixel. Specific examples of such a wavelength are, for example, 610 nm in the case of a red pixel, 545 nm in the case of a green pixel, and 450 nm in the case of a blue pixel.

The green pixel to be employed in a color filter according to a first embodiment of the present invention is formed of a color composition containing a pigment carrier made of at least a transparent resin or a mixture thereof, halogenated zinc phthalocyanine-based green pigment, and at least one kind of yellow pigment. This green pixel is also designed such that the sum of the products of: (birefringence of a sample color film of each of pigments)×(weight ratio of each pigment) would be confined to no more than 0.006.

In a color filter including green pixel formed of the aforementioned color composition, it is possible to carry out the retardation control by adjusting the absolute value of retardation in thickness direction (Rth) of the green pixel, which can be represented by the following equation, to no more than 2 nm.

Rth={(Nx+Ny/2−Nz)/2−Nz}×d

wherein Nx is a refractive index in x-direction in the plane of green pixel; Ny is a refractive index in y-direction in the plane of green pixel; and Nz is a refractive index in thickness direction of the green pixel. Herein, Nx is defined as a slow axis represented by Nx≧Ny; and d is a thickness (nm) of the green pixel.

A liquid crystal display device provided with the aforementioned color filter is capable of exhibiting a high contrast and excellent oblique visibility. If the absolute value of retardation in thickness direction (Rth) is larger than 2 nm, the designing of the liquid crystal and other optical components of liquid crystal panel would become difficult and also the oblique visibility would be deteriorated.

As a result of intensive studies made by the present inventors on the photosensitive composition to be used for forming the green pixel of the color filter, it has been found out that if the photosensitive composition is formulated to contain halogenated zinc phthalocyanine-based green pigment and at least one kind of yellow pigment and the mixing ratio of these pigments is suitably adjusted, it is possible to obtain a photosensitive color composition for the color filter, which is excellent in performance. Namely, the photosensitive composition thus obtained is excellent in sensitivity and in developing properties, is capable of forming a green layer (green pixel) exhibiting no more than 2 nm in the absolute value of retardation in thickness direction (Rth) after curing by light irradiation and/or baking, and is excellent in sensitivity, in adhesion to a substrate, in solvent resistance and in alkali resistance, thereby making it possible to solve all of the aforementioned problems of the prior art.

With respect to the aforementioned at least one kind of yellow pigment, it may be a combination of yellow pigments exhibiting a different spectral distribution from each other. However, it is more preferable to employ those exhibiting a color difference of: ΔEab≦3 and having the same spectral distribution with each other or very close spectral distribution to each other so that the spectral distribution thereof is substantially the same with each other. By doing so, it is possible to keep constant the color of the color composition and of the thin film thereof, thereby making it possible to facilitate the design of the color composition and the color filter. In this case, one or not less than two kinds of yellow pigment to be contained in the green pixel to be used in the manufacture of the color filter may more preferably be no more than 3 in color difference ΔEab as measured under the light source to be used in a liquid crystal display device into which the color filter is incorporated.

Further, in the color filter substrate according to this embodiment of the invention, the locus of chromaticity (x, y) based on the C-light source of green pixel is required to be regulated so as to enable the locus to fall within a region A encircled by lines connecting four points of: (0.255, 0.625), (0.275, 0.580), (0.325, 0.580) and (0.305, 0.625).

Incidentally, the chromaticity in this case represents values to be derived when the film thickness of the coated color film constituting the green pixel is that generally employed in the color filter (around 1.4-3 μm).

This region A is a proper range for the color filter to be used in a liquid crystal display which is designed to be employed in the ordinary television image display device and is intended to approximately satisfy the standard of the European Broadcasting Union (EBU). As long as the locus of chromaticity (x, y) based on the C-light source falls within region A, it is possible to obtain a liquid crystal display approximately satisfying the standard of the EBU. However, if this locus of chromaticity (x, y) falls outside region A, it is difficult to obtain a liquid crystal display satisfying the standard of the EBU.

Simultaneously, the color composition for the color filter to be employed in this embodiment of invention is required to be adjusted in such a way that when the chromaticity based on the C-light source is set to y=0.600, the luminosity Y of the coated film formed using this color composition becomes not less than 57.0. If the luminosity Y is lower than 57.0, the color filter to be obtained may become inappropriate as a color filter to be employed in a liquid display which is designed to be used especially in a television image display device which is severely demanded to save the power consumption in recent years. By enhancing the luminosity, it is possible to reduce not only the brightness of back light but also the power consumption.

In the color filter substrate as explained above, at least one kind of yellow pigment mentioned above may contain two kinds of yellow pigment, i.e., C.I. Pigment Yellow 138 and C.I. Pigment Yellow 150.

As described above, since the pigments constituting the green pixel include halogenated zinc phthalocyanine-based green pigment and at least one kind of yellow pigment, it is possible to control the retardation without causing changes in various properties including physical properties of color filter. In other words, the designing of a liquid crystal display panel can be facilitated by making use of a color filter substrate exhibiting an optimal retardation which is suited to a combination thereof with other components such as a phase plate or to the driving system of liquid crystal.

Therefore, by regulating the sum of the products of: (birefringence of organic pigments constituting the green pixel)×(weight ratio of these organic pigments) to no more than 0.006, the Rth of the green pixel can be made close to zero, thereby making it possible to provide a liquid crystal display device which is excellent in viewing angle characteristics.

Next, the color filter substrate according to the first embodiment of the present invention, which is used in a liquid crystal display device, will be explained.

Generally, the color filter substrate for a liquid crystal display device includes a black matrix formed on a transparent substrate and color pixels of three colors, i.e., red pixels, green pixels and blue pixels formed in regions partitioned by the black matrix. Incidentally, the color pixels may not be restricted to three colors but may be a combination of complementary colors or a combination of at least three colors containing complementary colors and the other color.

Incidentally, if it is desired to obtain excellent front visibility, especially if it is desired to obtain tightened and low brightness black when displaying the darkened or OFF state, the particle size distribution of the primary particle of pigment may preferably be regulated such that the particle diameter d50 which corresponds to 50% of a total of integrated quantity in a cumulative curve of number particle size distribution is confined to no more than 40 nm, more preferably no more than 30 nm. When the particle diameter d50 of the primary particle of pigment is regulated so as to fall within this range, it is possible to obtain a liquid crystal display device which is excellent in visibility not only from an oblique direction but also from the front face direction.

For the formation of the red pixel, it is possible to employ red pigments such as C.I. Pigment Red 7, 14, 41, 48:2, 48:3, 48:4, 81:1, 81:2, 81:3, 81:4, 146, 168, 177, 178, 179, 184, 185, 187, 200, 202, 208, 210, 246, 254, 255, 264, 270, 272, 279, etc. These red pigments may be employed together with a yellow pigment or an orange pigment.

Examples of the yellow pigment include C.I. Pigment Yellow 1, 2, 3, 4, 5, 6, 10, 12, 13, 14, 15, 16, 17, 18, 24, 31, 32, 34, 35, 35:1, 36, 36:1, 37, 37:1, 40, 42, 43, 53, 55, 60, 61, 62, 63, 65, 73, 74, 77, 81, 83, 93, 94, 95, 97, 98, 100, 101, 104, 106, 108, 109, 110, 113, 114, 115, 116, 117, 118, 119, 120, 123, 126, 127, 128, 129, 138, 139, 147, 150, 151, 152, 153, 154, 155, 156, 161, 162, 164, 166, 167, 168, 169, 170, 171, 172, 173, 174, 175, 176, 177, 179, 180, 181, 182, 185, 187, 188, 193, 194, 198, 199, 213, 214, etc. For the purpose of toning, dyes may be incorporated as long as the incorporation thereof would not deteriorate the heat resistance of the color filter to be obtained. Examples of yellow dye include azo dye, pyrazolone dye, anthraquinone dye, etc.

Examples of the orange pigment include C.I. Pigment Orange 36, 43, 51, 55, 59, 61, 71, 73, etc.

Further, for the purpose of adjusting the hue, the red pixel may contain yellow pigments or orange pigments. In view of increasing the contrast, it is more preferable to employ azo-metal complex-based yellow pigment. The quantity of these yellow pigments to be used may preferably be confined to 5-25 wt % based on a total weight of pigments. If the quantity of these yellow pigments is less than 5 wt %, it may become difficult to adjust the hue, e.g., to increase sufficiently luminosity. On the other hand, when the quantity of these yellow pigments is more than 30 wt %, the hue of the red pixel may be excessively shifted to yellow, thereby deteriorating the color-reproducing property.

In the formation of the red pixel as described above, it is more preferable to employ C.I. Pigment Red 254 as a diketopyrrolopyrrole-based red pigment, C.I. Pigment Red 177 as an anthraquinone-based red pigment, and C.I. Pigment Yellow 150 as an azo-metal complex-based yellow pigment in view of excellence in light resistance, heat resistance, transparency and coloring power.

Furthermore, in order to regulate the spectral characteristics of color filter, plural kinds of pigments may be used in combination. The pigments may preferably be incorporated at a ratio of 5-70% by mass based on an entire quantity (100% by mass) of solid matters of the color composition.

Further, in order to secure excellent coating properties, sensitivity, developing properties while making it possible to retain balance between the chroma and luminocity, the aforementioned organic pigments may be used in combination with inorganic pigments. Examples of the inorganic pigments include metal oxide powder, metal sulfide powder or metal powder such as yellow lead, zinc chrome, red iron oxide (III), cadmium red, ultramarine blue, Prussian blue, chromium oxide green, cobalt green, etc. For toning, the color composition may further contain dyes as long as the heat resistance of the color composition does not deteriorate.

Green pixel may contain, in addition to halogenated zinc phthalocyanine-based green pigment constituting a major pigment such as brominated zinc phthalocyanine-based green pigment (such for example as C.I. Pigment Green 58), the aforementioned yellow pigments. With respect to specific examples of the yellow pigments, the same kinds of pigments as described above in connection with the red pigment may be used. With respect to the green pigments, in addition to halogenated zinc phthalocyanine-based green pigment such for example as C.I. Pigment Green 58, other kinds of halogenated metal phthalocyanine-based green pigment such for example as C.I. Pigment Green 7, 10, 36, 37, etc., may be co-used as long as the retardation and color of the green pixel are badly affected.

The zinc halide phthalocyanine-based green pigment wherein the central metal atom thereof is zinc, such as brominated zinc phthalocyanine-based green pigment is higher in luminosity as compared with halogenated copper phthalocyanine-based green pigment wherein the central metal atom thereof is copper and hence the halogenated zinc phthalocyanine-based green pigment is preferably employed. Further, azo-based yellow pigment has a plus Rth irrespective of pulverizing treatment thereof. Quinophthalone-based yellow pigment has a minus Rth irrespective of pulverizing treatment thereof. In order to control the Rth or adjust the luminosity or hue of the color filter, these azo-based yellow pigment and quinophthalone-based yellow pigment may be selectively co-used.

Specific examples of the aforementioned metal halide phthalocyanine-based green pigment include C.I. Pigment Green 7, 36 and 58. In view of realizing excellent light resistance, heat resistance, transparency and coloring power, C.I. Pigment Yellow 150 as the azo-based yellow pigment and C.I. Pigment Yellow 138 as the quinophthalone-based yellow pigment is preferably employed.

For the formation of the blue pixel, it is possible to employ blue pigments such as C.I. Pigment Blue 15, 15:1, 15:2, 15:3, 15:4, 15:6, 16, 22, 60, 64, etc. Further, this blue pigment may be used together with a violet pigment. Specific examples of violet pigment include C.I. Pigment Violet 1, 19, 23, 27, 29, 30, 32, 37, 40, 42, 50, etc.

When the blue pixel includes metal phthalocyanine-based blue pigment and/or dioxazine-based violet pigment among the aforementioned pigments, it would become easier to obtain a Rth value ranging from minus to nearly zero. With respect to the quantity of using these pigments, the content of the metal phthalocyanine-based blue pigment may be confined to 40-100 wt % and the content of the dioxazine-based violet pigment may be confined to 0-50 wt %, preferably 1-50 wt % in view of the hue, luminosity, film thickness of the blue pixel. More preferably, the content of the metal phthalocyanine-based blue pigment may be confined to 50-98 wt % and the content of the dioxazine-based violet pigment may be confined to 2-25 wt %.

In view of realizing excellent light resistance, heat resistance, transparency and coloring power, C.I. Pigment Blue 15:6 as the metal phthalocyanine pigment and C.I. Pigment Violet 23 as the dioxazine-based violet pigment is preferably employed.

(Dispersing Agent)

In order to disperse the pigment in a pigment carrier and in an organic solvent, a dispersing agent or a surfactant is required. With respect to the dispersing agent, it is possible to employ a surfactant, an intermediate product of pigment, an intermediate product of dye, a derivative of these intermediate products, or a Solsperse, etc. Each of these dispersing agents has a pigment affinity moiety exhibiting pigment-adsorbing properties and another moiety exhibiting compatibility to a pigment carrier, thereby enabling the dispersing agents to adsorb onto the pigment and to stabilize the dispersion of the pigment in the pigment carrier.

Specific examples of the dispersing agent include polyurethane, polycarboxylate such as polyacrylate, unsaturated polyamide, polycarboxylic acid, (partial) amine polycarboxylate, ammonium polycarboxylate, alkyl amine polycarboxylate, polysiloxane, long chain polyaminoamide phosphate, hydroxyl group-containing polycarboxylate, modified compounds of these compounds, an oily dispersing agent such as amide formed through a reaction between poly(lower alkyl imine) and polyester having a free carboxyl group and salts of the amide, (metha)acrylic acid-styrene copolymer, (metha)acrylic acid-(metha)acrylate copolymer, styrene-maleic acid copolymer, water-soluble resin or water-soluble polymer such as polyvinyl alcohol and poly(vinyl pyrrolidone), polyester compounds, modified polyacrylate compounds, ethylene oxide/propylene oxide adduct, phosphate based compounds, etc. These compounds may be employed individually or in combination of two or more kinds.

Although there is not any particular limitation with regard to the addition amount of the dispersing agent, it is preferable to incorporate the dispersing agent at a ratio of 1-10% by mass based on 100% by mass of pigments. Further, The color composition may preferably be formulated such that bulky particles 5 μm or more in size, preferably, bulky particles 1 μm or more in size, more preferably, bulky particles 0.5 μm or more in size as well as dusts intermingled therein are removed from the composition by making use of centrifugal separation, sintered filter, membrane filter, etc.

(Surfactants)

Examples of the surfactant include an anionic surfactant such as polyoxyethylene alkylether sulfate, dodecylbenzene sodium sulfonate, alkaline salts of styrene-acrylic acid copolymer, alkylnaphthaline sodium sulfonate, alkyldiphenyl ether sodium disulfonate, monoethanol amine lauryl sulfate, triethanol amine lauryl sulfate, ammonium lauryl sulfate, monoethanol amine stearate, sodium stearate, sodium lauryl sulfate, monoethanol amine of styrene-acrylic acid copolymer, polyoxyethylene alkylether phosphate, etc.; a nonionic surfactant such as polyoxyethylene oleyl ether, polyoxyethylene lauryl ether, polyoxyethylene nonylphenyl ether, polyoxyethylene alkylether phosphate, polyoxyethylene sorbitan monostearate, polyethyleneglycol monolaurate, etc.; cationic surfactant such as alkyl quaternary ammonium salt and an ethylene oxide adduct thereof, etc.; and an amphoteric surfactant such as alkyl betaine such as betaine alkyldimethyl aminoacetate, alkylimidazoline, etc. These surfactants can be employed singly or in combination of two or more kinds.

(Acrylic Resin)

Examples of acrylic resin are as follows.

Namely, acrylic resin includes polymers formed using monomers such for example as (metha)acrylic acid; alkyl (metha)acrylate including methyl (metha)acrylate, ethyl (metha)acrylate, propyl (metha)acrylate, butyl

(metha)acrylate, t-butyl (metha)acrylate, benzyl (metha)acrylate, lauryl (metha)acrylate, etc.; hydroxyl group-containing (metha)acrylate such as hydroxyethyl (metha)acrylate, hydroxypropyl (metha)acrylate, etc.; ether-containing (metha)acrylate such as ethoxyethyl (metha)acrylate, glycidyl (metha)acrylate, etc.; and alicyclic (metha)acrylate such as cyclohexyl (metha)acrylate, isobornyl (metha)acrylate, dicyclopentenyl (metha)acrylate, etc.

Incidentally, these monomers can be used singly or in combination of two or more kinds. Further, other kinds of compounds which can be co-polymerized with these monomers such as styrene, cyclohexyl maleimide, phenyl maleimide, etc., can be used as a copolymer.

It is also possible to obtain photosensitive resins through the reaction between a copolymer of carboxylic acid having an ethylenic unsaturated group such as (metha)acrylic acid and a compound having epoxy group and unsaturated double bond such as glycidyl methacrylate or through the addition of a carboxylic acid-containing compound such as (metha)acrylic acid to a polymer of epoxy group-containing (metha)acrylate such as glycidyl methacrylate or to a copolymer of epoxy group-containing (metha)acrylate with other kinds of (metha)acrylate.

It is also possible to obtain a photosensitive resin through the reaction between a polymer having hydroxyl group and constituted by a monomer such as hydroxyethyl methacrylate and a compound having an isocyanate group and an ethylenic unsaturated group such as methacryloyloxyethyl isocyanate.

Further, a resin having carboxylic group can be obtained through a reaction between a copolymer of hydroxyethyl methacrylate having a plurality of hydroxyl groups and a polybasic acid anhydride, thereby introducing carboxylic group into the copolymer. The manufacturing method thereof may not be limited to the above-described method.

Specific examples of the acid anhydride to be employed in the aforementioned reaction include, for example, malonic anhydride, succinic anhydride, maleic anhydride, itaconic anhydride, phthalic anhydride, tetrahydrophthalic anhydride, hexahydrophthalic anhydride, methyltetrahydrophthalic anhydride, trimellitic anhydride, etc.

The acid value of solid matter of above-described acrylic resin should preferably be confined to 20-180 mgKOH/g. If this acid value is less than 20 mgKOH/g, the developing rate of the photosensitive resin composition becomes too slow, thereby taking a lot of time for executing the development thereof, thus leading to the decrease of productivity. On the other hand, if the acid value of solid matter is larger than 180 mgKOH/g, the developing rate of the photosensitive resin composition becomes too fast on the contrary, thereby inviting the generation of problems such as peeling of pattern after the development thereof or the chip-off of pattern.

Further, in the case where the aforementioned acrylic resin is photosensitive, the double-bond equivalent of the acrylic resin should preferably be not less than 100, more preferably 100-2000, most preferably 100-1000. If the double-bond equivalent thereof is higher than 2000, it may become difficult to secure sufficient photocuring properties.

(Photopolymerizable Monomer)

Specific examples of the photopolymerizable monomer include various kinds of acrylic esters and methacrylic esters such as 2-hydroxyethyl(metha)acrylate, 2-hydroxypropyl(metha)acrylate, cyclohexyl(metha)acrylate, polyethyleneglycol di(metha)acrylate, pentaerythritol tri(metha)acrylate, trimethylolpropane tri(metha)acrylate, dipentaerythritol hexa(metha)acrylate, tricyclodecanyl (metha)acrylate, melamine (metha)acrylate, epoxy(metha)acrylate, etc.; (metha)acrylic acid; styrene; vinyl acetate; (metha)acryl amide; N-hydroxymethyl (metha)acryl amide; acrylonitrile; etc.

Further, it is preferable to employ polyfunctional urethane acrylate having (metha)acryloyl group which can be obtained through the reaction between (metha)acrylate having hydroxyl group and polyfunctional isocyanate. Incidentally, the combination between the (metha)acrylate having hydroxyl group and polyfunctional isocyanate may be optionally selected and hence there is not any particular limitation. Further, only one kind of polyfunctional urethane acrylate may be used singly or polyfunctional urethane acrylate may be used in a combination of two or more kinds thereof.

(Photopolymerization Initiators)

Specific examples of the photopolymerization initiator include an acetophenone-based compound such as 4-phenoxy dichloroacetophenone, 4-t-butyl-dichloroacetophenone, diethoxyacetophenone, 1-(4-isopropylphenyl)-2-hydroxy-2-methylpropan-1-one, 1-hydroxycyclohexylphenyl ketone, 2-benzyl-2-diamino-1-(4-morpholinophenyl)-butan-1-one; a benzoin-based compound such as benzoin, benzoin methyl ether, benzoin ethyl ether, benzoin isopropyl ether, benzyldimethyl ketal, etc.; a benzophenone-based compound such as benzophenone, benzoylbenzoic acid, benzoylmethyl benzoate, 4-phenyl benzophenone, hydroxybenzophenone, acrylated benzophenone, 4-benzoyl-4′-methyldiphenyl sulfide, etc.; a thioxanthone-based compound such as thioxanthone, 2-chlorothioxanthone, 2-methylthioxanthone, isopropylthioxanthone, 2,4-diisopropylthioxanthone, etc.; a triazine-based compound such as 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-piperonyl-4,6-bis(trichloromethyl)-s-triazine, 2,4-bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-riazine, 2,4-trichloromethyl-(piperonyl)-6-triazine, 2,4-trichloromethyl(4′-methoxystyryl)-6-triazine, etc.; an oxime ester-based compound such as 1,2-octanedione, 1-[4-(phenylthio)-2-(O-benzoyloxime)], O-(acetyl)-N-(1-phenyl-2-oxo-2-(4′-methoxynaphthyl)ethylidene) hydroxylamine, etc.; a phosphine-based compound such as bis(2,4,6-trimethylbenzoyl)phenylphosphine oxide, 2,4,6-trimethylbenzoyl diphenylphosphine oxide, etc.; a quinone-based compound such as 9,10-phenanthrene quinone, camphor quinone, ethyl anthraquinone, etc.; a borate-based compound; a carbazol-based compound; an imidazole-based compound, a titanocene-based compound, etc. These photopolymerization initiators can be employed singly or in combination of two or more kinds thereof.

(Photosensitizer)

It is preferable to use these photopolymerization initiators in combination with a photosensitizer. Specific examples of the photosensitizer include α-acyloxy ester, acylphosphine oxide, methylphenyl glyoxylate, benzyl, 9,10-phenanthrene quinone, camphor quinone, ethylanthraquinone, 4,4′-diethyl isophthalophenone, 3,3′,4,4′-tetra(t-butyl peroxycarbonyl)benzophenone, 4,4′-diethyl aminobenzophenone, etc.

These sensitizers can be incorporated at a ratio of 0.1 to 60 parts by mass based on 100 parts by mass of the photopolymerization initiator.

(Non-Photosensitive Resin and/or Photosensitive Resin)

The color composition for use in the color filter substrate according to the first embodiment of the present invention may be formulated so as to include a non-photosensitive transparent resin and/or a photosensitive transparent resin preferably exhibiting a permeability of not less than 80%, more preferably not less than 95% in a total wavelength range of 400-700 nm of visible light range.

Specific examples of the transparent resin include thermoplastic resin, thermosetting resin and photosensitive resin. Examples of the thermoplastic resin include, for example, butyral resin, styrene-maleic acid copolymer, chlorinated polyethylene, chlorinated polypropylene, polyvinyl chloride, vinyl chloride-vinyl acetate copolymer, polyvinyl acetate, polyurethane resin, polyester resin, acrylic resin, alkyd resin, polystyrene, polyamide resin, rubber resin, cyclized rubber-based resin, celluloses, polybutadien, polyethylene, polypropylene, polyimide, etc. Examples of the thermosetting resin include, for example, epoxy resin, benzoguanamine resin, rosin-modified maleic resin, rosin-modified fumaric acid resin, melamine resin, urea resin, phenol resin, etc. It is also possible to employ, as thermosetting resin, compounds to be obtained through a reaction between melamine resin having a formula (1) described below and a compound having isocyanate group.

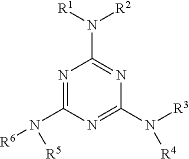

(wherein R¹-R⁶ may be the same or different and are individually hydrogen atom or CH₂OR [R is a hydrogen atom or alkyl group and may be the same or different in R¹-R⁶.])

It is also possible to co-use two or more kinds of homopolymers or copolymers. It is also possible to use, other than the above-described compounds, a compound having 1,3,5-triazine ring which is shown in JP-A 2001-166144. It is also possible to preferably use the compounds represented by the following formula (2).

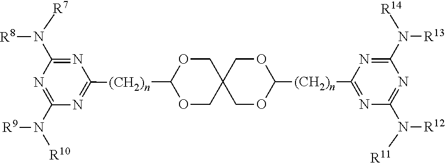

(wherein R⁷-R¹⁴ may be the same or different and are individually hydrogen atom, alkyl group, alkenyl group, aryl group or heterocyclic group, a hydrogen atom being most preferable among these groups)

Specific examples of the compound having isocyanate group and being useful in the aforementioned reaction include various kinds of known isocyanates such as aromatic, aliphatic or alicyclic isocyanates.

For example, it is possible to employ aromatic polyisocyanate such as 1,5-naphthylene diisocyanate, 4,4′-diphenyl methane diisocyanate, 4,4′-diphenyldimethyl methane diisocyanate, 4,4′-dibenzyl diisocyanate, dialkyldiphenyl methane diisocyanate, tetraalkyldiphenyl methane diisocyanate, 1,3-phenylene diisocyanate, 1,4-phenylene diisocyanate, tolylene diisocyanate, xylylene diisocyanate, m-tetramethyl xylylene diisocyanate, etc.; aliphatic polyisocyanate such as butane-1,4-diisocyanate, hexamethylene diisocyanate, isopropylene diisocyanate, methylene diisocyanate, 2,2,4-trimethylhexamethylene diisocyanate, 2,4,4-trimethylhexamethylene diisocyanate, etc.; alicyclic polyisocyanate such as cyclohexane-1,4-diisocyanate, isophorone diisocyanate, lysine diisocyanate, dicyclohexylmethane-4,4′-diisocyanate, 1,3-bis(isocyanate methyl)cyclohexane, methylcyclohexane diisocyanate, etc.; and dimer diisocyanate wherein carboxyl group of dimer acid is converted to isocyanate group.

When it is desired to impart photosensitivity to the thermosetting resin, a compound having isocyanate group and a double-bonding group can be suitably employed. Examples of such a compound include 2-acryloyloxyethyl isocyanate, 2-methacryloyloxyethyl isocyanate, 1,1′-(bisacryloyloxymethyl)ethyl isocyanate, etc.

Examples of an acid anhydride to be used in the aforementioned reaction include malonic anhydride, succinic anhydride, maleic anhydride, itaconic anhydride, phthalic anhydride, hexahydrophthalic anhydride, tetrahydrophthalic anhydride, methyltetrahydrophthalic anhydride, etc.

In this thermosetting resin, the acid value thereof should preferably be confined, as reduced based on solid matter, to 3-60 mgKOH/g, more preferably 20-50 mgKOH/g. Accordingly, the addition reaction of the acid anhydride is performed quantitatively so as to confine the acid value to fall within this range.

If this acid value is less than 3 mgKOH/g, defective development may be caused to occur in the alkali-developing process. On the other hand, if this acid value is larger than 60 mgKOH/g, various problems would be caused to occur such as invasion of the surface of exposure portions by a developing solution in the process of alkali-development or deterioration of long-term storage stability of the photosensitive resin composition.

The aforementioned thermosetting resin can be prepared according any one of the following methods.

(1) A method wherein melamine resin is mixed and reacted with a compound having isocyanate group while warming the mixture.

(2) A method wherein melamine resin is mixed and reacted with a compound having isocyanate group while warming the mixture and then an acid anhydride is added thereto and allowed to react with the mixture while warming the mixture.

(3) A method wherein melamine resin is mixed and reacted with an acid anhydride while warming the mixture.

These methods may further include, as pretreatments, a step of distilling out low-boiling alcohol compounds by making use of an evaporator and a step of solvent replacement using another solvent which is suited for the photosensitive resin composition.

Generally speaking, thermosetting resins such as melamine resin are high in thermal reactivity and poor in long-term storage stability, so that it has been considered difficult to incorporate a large quantity of thermosetting resin in the photosensitive resin composition. In the case of the aforementioned thermosetting resins however, since some of a plurality of thermally reactive groups existing in the skeleton of melamine resin are consumed for the reaction thereof with a compound or acid anhydride having isocyanate group, the thermal reactivity thereof is appropriately reduced, thereby making them effective in improving the long-term storage stability of the photosensitive resin composition. Furthermore, as a result of the reaction of melamine resin with a compound or acid anhydride having isocyanate group, the polymer chain of melamine resin is elongated to restrain the free movement of the skeleton of melamine resin, thereby bringing about advantages of improving the storage stability thereof.

By way of the reaction of melamine resin with a compound or acid anhydride having isocyanate group, it is possible to impart alkali-developing property and/or photosensitivity, both required in an alkali-developing photosensitive resin composition, to the melamine resin. By providing the melamine resin with alkali-developing property and/or photosensitivity, the adhesion thereof to a substrate can be improved, thereby realizing a photosensitive resin composition which is excellent in process margin so as to prevent the generation of problems in the step of development.

Furthermore, due to the inclusion of the aforementioned thermosetting resin in the photosensitive resin composition, it is not only possible to impart a sufficient heat resistance and hardness to a coated film that has been cured but also possible to impart solvent resistance and alkali resistance to the coated film.

Additionally, when an appropriate quantity of the thermosetting resin is incorporated in the photosensitive resin composition, it is not only possible to minimize the elution of ionic impurities which are contained in pigments or in other kinds of particulate or which are intruded into the photosensitive resin composition during the manufacture of the photosensitive resin composition but also possible to improve the electrical characteristics of the photosensitive resin composition. Namely, the reaction of the thermosetting resin is taken place in the photosensitive resin composition when baking and curing the photosensitive resin composition for the formation of the coloring layer, the counter substrate-carrying layer, the bulking layer for controlling cell gap and the phase shifting layer, thereby enabling pigments and other kinds of particulate to be trapped inside the mesh of polymer, thus making it possible to inhibit the elution of ionic impurities.

Furthermore, when an appropriate quantity of the thermosetting resin is incorporated in the photosensitive resin composition, the aromatic ring of the thermosetting resin is enabled to act electronically, thus making it possible to adjust the electrical characteristics of the cured film. As a result, it is now possible to provide a liquid crystal display device which is excellent in electrical characteristics and is free from seizing and color drift even if the display device is used for long hours.

(Polyfunctional Thiol)

The photosensitive resin composition may contain polyfunctional thiol which is capable of acting as a chain-transfer agent. The polyfunctional thiol is useful as long as the compound thereof has two or more thiol groups. Specific examples of the polyfunctional thiol include hexane dithiol, decane dithiol, 1,4-butanediol bisthiopropionate, 1,4-butanediol bisthioglycolate, ethyleneglycol bisthioglycolate, ethyleneglycol bisthiopropionate, trimethylolpropane tristhioglycolate, trimethylolpropane tristhiopropionate, trimethylolpropane tris(3-mercaptobutylate), pentaerythritol tetrakisthioglycolate, pentaerythritol tetrakisthiopropionate, trimercaptopropionate tris(2-hydroxyethyl)isocyanulate, 1,4-dimethylmercaptobenzene, 2,4,6-trimercapto-s-triazine, 2-(N,N-dibutylamino)-4,6-dimercapto-s-triazine, etc.

These polyfunctional thiols can be employed singly or in combination of two or more kinds. The content of these polyfunctional thiols should preferably be confined to 0.2-150 parts by mass, more preferably 0.2-100 parts by mass based on 100 parts by mass of the pigment in the color composition.

(Storage Stabilizing Agent)

The photosensitive resin composition may further contain a storage stabilizing agent for stabilizing the time viscosity of the composition. Specific examples of the storage stabilizing agent include, for example, quaternary ammonium chlorides such as benzyltrimethyl chloride, diethylhydroxy amine, etc.; organic acids such as lactic acid, oxalic acid, etc., and methyl ethers thereof; t-butyl pyrocatechol; organic phosphine such as triethyl phosphine, triphenyl phosphine, etc.; phosphite; etc. The storage stabilizing agent can be employed at a ratio of 0.1-10 parts by mass based on 100 parts by mass of the pigments in a coloring composition.

(Adherence Improver)

Further, the photosensitive resin composition may contain an adherence improver such as a silane coupling agent for the purpose of enhancing the adhesion thereof to a substrate. Specific examples of the silane coupling agent include vinyl silanes such as vinyl tris(β-methoxyethoxy) silane, vinylethoxy silane, vinyltrimethoxy silane, etc.; (metha)acrylsilanes such as γ-methacryloxypropyl silane, etc.; epoxy silanes such as β-(3,4-epoxycyclohexyl)ethyltrimethoxy silane, β-(3,4-epoxycyclohexyl)methyltrimethoxy silane, β-(3,4-epoxycyclohexyl)ethyltriethoxy silane, β-(3,4-epoxycyclohexyl)methyltriethoxy silane, γ-glycidoxypropyl trimethoxy silane, γ-glycidoxypropyl triethoxy silane, etc.; amino silanes such as N-β(aminoethyl) γ-aminopropyl trimethoxy silane, N-β(aminoethyl) γ-aminopropyl triethoxy silane, N-β(aminoethyl) γ-aminopropyl methyldiethoxy silane, γ-aminopropyl triethoxy silane, γ-aminopropyl trimethoxy silane, N-phenyl-γ-aminopropyl trimethoxy silane, N-phenyl-γ-aminopropyl triethoxy silane, etc.; and thiosilanes such as γ-mercaptopropyl trimethoxy silane, γ-mercaptopropyl triethoxy silane, etc. These silane coupling agents can be incorporated at a ratio of 0.01-100 parts by mass based on 100 parts by mass of the pigments in a coloring composition.

(Solvents)

The photosensitive resin composition may further contain a solvent such as water, organic solvents, etc., for enabling the photosensitive resin composition to be uniformly coated on the surface of a substrate. Further, in the case where the photosensitive resin composition of the present invention is to be used for constituting the color layer of color filter, the solvent acts to enable pigments to be uniformly dispersed in the color layer. Specific examples of the solvent include, for example, cyclohexanone, ethyl Cellosolve acetate, butyl Cellosolve acetate, 1-methoxy-2-propyl acetate, diethyleneglycol dimethyl ether, ethyl benzene, ethyleneglycol diethyl ether, xylene, ethyl Cellosolve, methyl-n amyl ketone, propyleneglycol monomethyl ether, toluene, methylethyl ketone, ethyl acetate, methanol, ethanol, isopropyl alcohol, butanol, isobutyl ketone, petroleum solvent, etc. These solvents may be employed singly or in combination of two or more kinds. The mixing ratio of these solvents may be confined to the range of 800 to 4000 parts by mass, preferably 1000 to 2500 parts by mass based on 100 parts by mass of the pigments in the color composition.

(Method of Preparing the Photosensitive Resin Composition)

The photosensitive resin composition can be prepared by way of any conventional method. For example, a photosensitive color composition containing a photopolymerizable monomer, a thermosetting resin, a pigment, a dispersing agent and a solvent may be prepared according to the following methods.

(1) A pigment composition that has been prepared in advance through the mixing of a pigment with a dispersing agent is added to and dispersed in a photopolymerizable monomer and in the thermosetting resin of the present invention or in a solution comprising these components dissolved in a solvent. Then, residual components are added to the resultant dispersion.

(2) A pigment and a dispersing agent are separately added to and dispersed in a photopolymerizable monomer and in the thermosetting resin of the present invention or in a solution comprising these components dissolved in a solvent. Then, residual components are added to the resultant dispersion.

(3) A pigment is added to and dispersed in a photopolymerizable monomer and in the thermosetting resin of the present invention or in a solution comprising these components dissolved in a solvent. Then, a dispersing agent is added to the resultant dispersion and then residual components are added to the resultant dispersion.

(4) Two kinds of materials each comprising a photopolymerizable monomer and the thermosetting resin of the present invention or two kinds of solutions each comprising these components dissolved in a solvent are prepared in advance and then a pigment and a dispersing agent are separately dispersed in aforementioned two kinds of materials. Then, these dispersions are mixed together and then residual components are added to the resultant dispersion. Incidentally, either the pigment or the dispersing agent may be dissolved only in the solvent.

Herein, the dispersion of the pigment and the dispersing agent in a photopolymerizable monomer and in the thermosetting resin of the present invention or in a solution comprising these components dissolved in a solvent may be performed by making use of various kinds of dispersing apparatus such as a triple roll mill, a twin-roll mill, a sand mill, a kneader, a dissolver, a high-speed mixer, a homomixer, an attritor, etc. Further, in order to execute the dispersion more preferably, the dispersion may be performed by the addition of various kinds of surfactant.

Although the preparation of a pigment composition through the preliminary mixing of a pigment with a dispersing agent may be performed by simply mixing a powdery pigment with a powdery dispersing agent, it is more preferable to employ the following mixing methods, i.e., (a) a mechanical mixing method using various kinds of grinders such as a kneader, a roll, an attritor, a super mill, etc.; (b) a method wherein a pigment is dispersed in a solvent to obtain a dispersion to which a solution containing a dispersing agent is added, thereby enabling the dispersing agent to be adsorbed onto the surface of pigment; (c) a method wherein a pigment and a dispersing agent are co-dissolved in a solvent exhibiting a strong dissolving power such as sulfuric acid and then co-precipitation is executed by making use of a poor solvent such as water, etc.

(Color Filter)

Next, a method for forming a color filter substrate will be explained. In the present invention, pixel units of a red layer, a green layer or a blue layer, each disposed in the openings of a black matrix, will be referred to as a red pixel, a green pixel and a blue pixel, respectively.

FIG. 1 is a cross-sectional view schematically illustrating the color filter substrate according to the first embodiment of the present invention.

As shown in FIG. 1, a black matrix 2 which is obtained through the patterning of a metal layer made of as chromium or a photosensitive black resin composition is formed on the surface of a substrate 1 by means of the conventional method. With respect to the substrate 1 to be employed herein, it is preferable to use a transparent substrate such as a glass substrate or a resinous substrate made of polycarbonate, poly-methyl methacrylate, polyethylene phthalate, etc. Further, for the purpose of driving liquid crystal molecules in a liquid crystal display panel, a transparent electrode made of a combination of metal oxides such as indium oxide, tin oxide, zinc oxide and antimony oxide may be formed on the surface of a glass plate or of a resinous plate.

Then, the aforementioned photosensitive resin composition for use in the color filter according to the first embodiment of the present invention is uniformly coated on the surface of the substrate 1 by any desired method such as spray coating, spin coating, roll coating, etc., thereby forming a layer, which is then dried to form a photosensitive resin composition layer. Then, by means of photolithography, the photosensitive resin composition layer thus formed is subjected to a patterning process. Namely, the photosensitive resin composition layer is exposed to an active energy beam such as ultraviolet rays, electron beam, etc., through a photomask having a desired light-shielding pattern and then the resultant photosensitive resin composition layer is subjected to a developing process by making use of a developing solution such as an organic solvent or an alkaline aqueous solution. In this exposure process, the photopolymerizable monomer contained in the photosensitive resin composition and located on the regions irradiated with the active energy beam is allowed to polymerize and cure. Further, when the photosensitive resin composition contains a photosensitive resin, this photosensitive resin is also allowed to cross-link and cure.

Further, in order to enhance the exposure sensitivity, a water-soluble or alkali-soluble resin (for example, polyvinyl alcohol or a water-soluble acrylic resin) may be coated, prior to the step of exposure, on the surface of the coated photosensitive resin composition layer and dried, thereby forming a film which is capable of suppressing the polymerization-inhibiting effects of oxygen.

Subsequently, in the step of the development, the portions of the photosensitive resin composition layer which are not irradiated with the active energy beam are washed out by making use of a developing solution to obtain a desired pattern. The method of developing treatment that can be employed includes a shower developing method, a spray developing method, a dip developing method, a paddle developing method, etc. Incidentally, with respect to the developing solution, an alkali developing solution such as an aqueous solution of sodium carbonate, sodium hydroxide, etc., or an organic alkaline solution such as dimethylbenzyl amine, triethanol amine, etc., may be mainly employed. Further, if required, the developing solution may contain a defoaming agent or a surfactant.

Finally, the resultant layer thus developed is baked, and the same procedures as described above are repeated for other colors, thus manufacturing a color filter. More specifically, red pixels 3R, green pixels 3G and blue pixels 3B are formed on the surface of substrate 1 having a black matrix 2 formed thereon. Namely, the color layer is constituted by these red pixels 3R, green pixels 3G, blue pixels 3B and the black matrix 2.

Moreover, in order to make uniform and regulate the cell gap of liquid crystal display device, a spacer may be formed on these color pixels. The spacer should preferably be formed on the black matrix.

Next, there will be explained about the liquid crystal display device which is provided with the color filter substrate explained above.

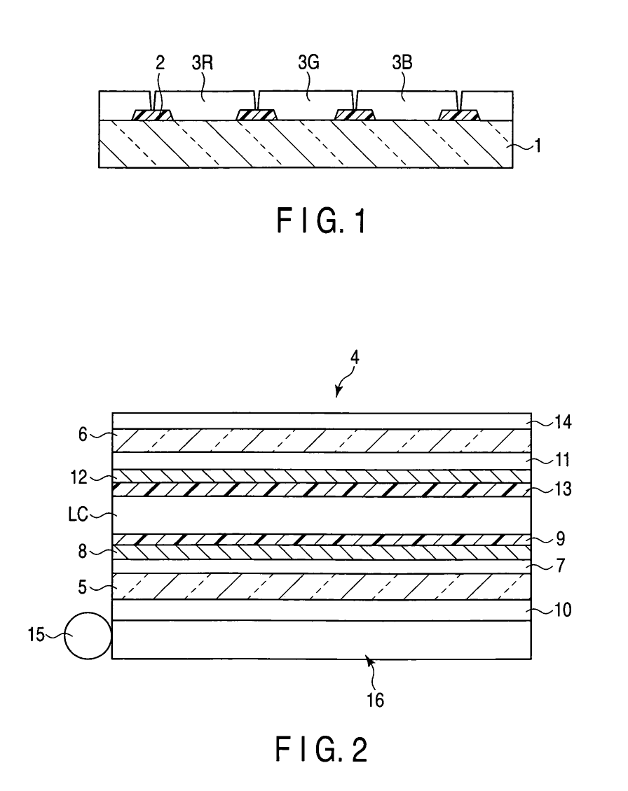

FIG. 2 is a cross-sectional view schematically illustrating the liquid crystal display device according to the second embodiment of the present invention.

The liquid crystal display device 4 shown in FIG. 2 illustrates a typical example of a TFT-drive liquid crystal display device which is provided with a pair of transparent substrates arranged face to face with a gap interposed therebetween and filled with a liquid crystal (LC).

In the second embodiment of the present invention, various kinds of liquid crystal (LC) can be employed such as twisted nematic (TN), super twisted nematic (STN), in-plane switching (IPS), vertical alignment (VA), optically compensated birefringence (OCB), etc. It is also possible to employ a liquid crystal-driving method called fringe field switching (FFS) wherein the transparent electrode (pixel electrode) disposed on the surface of color filter or on the substrate side having a TFT formed thereon is formed into a comb-like or stripe-like configuration.

On the inner wall of the first transparent substrate 6, there is formed a color filter 11. The red pixels, green pixels and blue pixels constituting the color filter 11 are separated from each other by a black matrix (not shown). If required, a transparent protective film (not shown) may be formed so as to cover the color filter 11. Furthermore, a transparent electrode layer 12 made of conductive composite oxide is formed on this protective film. An alignment layer 13 is formed so as to cover the transparent electrode layer 12. Incidentally, specific examples of the conductive composite oxide include a transparent metal oxide such as indium oxide-tin oxide-based material (ITO) and zinc oxide-based material.

On the other hand, on the inner wall of the second transparent substrate 5, there is formed a thin-film transistor (TFT) array 7 is formed. Furthermore, a transparent electrode layer 8 made of ITO for example is formed on the TFT array 7. On the surface of the transparent electrode layer 8, there is disposed an alignment layer 9. Further, a polarizing plate 14 including a retardation film is formed on the outer surface of the transparent substrate 6. Further, a polarizing plate 10 is formed on the outer surface of the transparent substrate 5. Incidentally, a back light unit 16 equipped with a triple wavelength lamp 15 is disposed below the polarizing plate 10.

### EXAMPLES

Although the present invention will be specifically explained below by referring to specific examples of the present invention and to comparative examples, it should not be construed that the present invention is limited to these examples. Further, since the materials to be employed in these examples are very sensitive to light, it is required to prevent the sensitization of the materials by redundant light such as natural light, so that every works were performed under the yellow or red lamp. Incidentally, “part(s)” in the following examples and comparative examples means weight part(s) or mass part(s). Further, the symbols of pigments are indicated by a color index number. For example, “PG36” means C.I. Pigment Green 36, and “PY150” means C.I. Pigment Yellow 150.

Pigment derivatives used in Examples are shown in the following Table 1.

TABLE 1

| Pigment derivative | Chemical structure |
|---|---|
| D-1 | 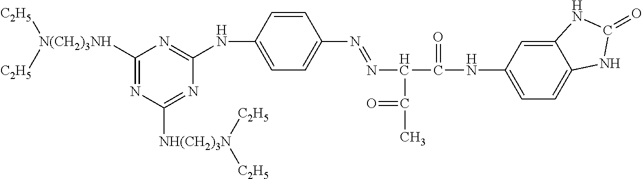 |

a) Manufacture of Pulverized Pigments

The pulverized pigments used in Examples and Comparative Examples were manufactured according to the following methods. An average primary particle diameter of the pigments thus obtained was measured according to an ordinary method wherein the size of primary particle was directly measured from the electron microscopic photograph thereof.

More specifically, by making use of a transmission electron microscope (JEM-2010; Nippon Denshi Co., Ltd.), the particles inside a view-field were photographed and then the minor axial length and major axial length of the primary particle of each of pigments constituting an aggregate appearing on the two-dimensional image thereof were measured. Then, an average of the measured values was taken to determine the particle diameter of pigment particles.

Then, at least 100 particles of pigment were respectively measured respectively with respect to the volume (weight) thereof in the assumption that each of particles was a rectangular allelepiped having the particle diameter to be determined, thus determining an average primary particle diameter based on the volume average particle diameter thus measured. In this case, the color composition employed as a sample was ultrasonically dispersed in a solvent before the particles thereof were photographed by means of the aforementioned microscope. Incidentally, the same results would be obtained irrespective of the types of electron microscope, i.e., a transmission type (TEM) or a scanning type (SEM). The primary particle diameter herein represents a particle diameter (a diameter equivalent to circle) which corresponds to 50% of a total of integrated quantity in a cumulative curve of number particle size distribution.

(Pigment-Manufacturing Example 1)

46 parts of zinc phthalocyanine was dissolved in a molten salt heated to 200° C. and consisting of 356 parts of aluminum chloride and 6 parts of sodium chloride. Then, the resultant solution was cooled to 130° C. and stirred for one hour. Thereafter, the reaction temperature was raised to 180° C. and bromine was added drop-wise at a rate of 10 parts per hour to this reaction mixture taking 10 hours. Then, chlorine was added at a rate of 0.8 parts per hour to this reaction mixture taking 5 hours.

The resultant reaction mixture was gradually poured into 3200 parts of water and then subjected to filtration and water washing to obtain 107.8 parts of crude zinc phthalocyanine halide pigment. An average number of bromine atoms included in one molecule of this crude zinc phthalocyanine halide pigment was 14.1 and an average number of chlorine atoms included in one molecule of this crude zinc phthalocyanine halide pigment was 1.9.

Then, 120 parts of this crude zinc phthalocyanine halide pigment, 1600 parts of pulverized sodium chloride, and 270 parts of diethylene glycol were put into a 1 gallon stainless steel kneader (Inoue Seisakusho Co., Ltd.) and kneaded for 12 hours at 70° C.

Then, the resultant mixture was poured into 5000 parts of hot water and stirred for about one hour by means of a high-speed mixer while heating it to about 70° C. to obtain a slurry product. This slurry product was then subjected to repeated filtration and water washing to remove sodium chloride and the solvent and dried for 24 hours at 80° C. to obtain 117 parts of a salt milling-treated pigment (G-1). The primary particle diameter of the pigment thus obtained is shown in the following Table 2.

(Pigment-Manufacturing Example 2)

160 parts of a yellow pigment (C.I. Pigment Yellow 138, BASF Co., Ltd.; Pariotol Yellow K0961HD), 1600 parts of sodium chloride and 270 parts of diethylene glycol (Tokyo Kasei Co., Ltd.) were put into a 1 gallon stainless steel kneader (Inoue Seisakusho Co., Ltd.) and kneaded for 15 hours at 60° C. Then, the resultant mixture was introduced into about 5 liters of hot water and stirred for about one hour by means of a high-speed mixer while heating it to about 70° C. to obtain a slurry product. This slurry product was then subjected to repeated filtration and water washing to remove the sodium chloride and the diethylene glycol and dried for 24 hours at 80° C. to obtain 157 parts of a salt milling-treated pigment (Y-1).

(Pigment-Manufacturing Example 3)

150 parts of water was put into a separable flask and then 63 parts of 35% hydrochloric acid was put into the separable flask with stirring to prepare a solution of hydrochloric acid. Then, while taking care of the generation of foaming, 38.7 parts of benzenesulfonyl hydrazide was poured into the solution and then ice was added to the resultant solution until the liquid temperature of the resultant solution was cooled to not higher than 0° C. After this cooling step, 19 parts of sodium nitrite was put into the resultant solution taking 30 minutes and stirred for 30 minutes at a temperature ranging from 0 to 15° C. Thereafter, sulfamic acid was added to the resultant solution until the coloring of a potassium iodide-starch paper was no longer admitted.

Then, after the addition of 25.6 parts of barbituric acid to the resultant solution, the temperature thereof was raised to 55° C. and stirred at this temperature for two hours. Then, 25.6 parts of barbituric acid was further added to the resultant solution and heated to 80° C. Then, sodium hydroxide was gradually added to the resultant solution until the pH thereof became 5. After being stirred for 3 hours at 80° C., the temperature of the solution was allowed to cool down to 70° C. and then subjected to filtration and hot-water washing.

The press-cake thus obtained was poured into 1200 parts of hot water to form a slurry, which was then stirred for two hours at 80° C. Thereafter, while keeping the temperature, the slurry was subjected to filtration and to hot-water washing using 2000 parts of hot water of 80° C., thereby confirming that benzenesulfone amide was moved to the filtrate thus obtained. The press-cake thus obtained was then dried at 80° C., thus obtained 61.0 parts of disodium azobarbiturate.

Then, 200 parts of water was put into a separable flask and then 8.1 parts of disodium azobarbiturate powder thus obtained was put into the separable flask with stirring to disperse the powder. After being uniformly dispersed, the resultant solution was heated to 95° C. and mixed with 5.7 parts of melamine and 1.0 parts of diallylamino melamine to obtain a mixed solution.

Further, 6.3 parts of cobalt(II) chloride hexahydrate was dissolved in 30 parts of water to obtain a green solution, which was then added drop-wise to the aforementioned mixed solution over 30 minutes. After finishing the addition of the green solution, the resultant solution was subjected to complexation for 1.5 hours at 90° C.

Subsequently, the pH of the resultant solution was adjusted to 5.5 and then 20.4 parts of an emulsion-like solution consisting of 4 parts of xylene, 0.4 parts of sodium oleate and 16 parts of water, which were agitated in advance, was added to the pH-adjusted solution and agitated under heating for 4 hours. After being cooled to 70° C., the solution was immediately subjected to filtration and to water washing using water of 70° C. until the inorganic salts was completely washed. Thereafter, the product thus obtained was subjected to the steps of drying and grinding to obtain 14 parts of azo-based yellow pigment (Y-2).

(Pigment-Manufacturing Example 4)

80 parts of a yellow pigment (C.I. Pigment Yellow 139, BASF Co., Ltd.; Pariotol Yellow 1819D) and 8 parts of oleic acid were put into a dry-type attritor (MAO1D, 0.8 L tank capacity, Mitsui Kozan Co., Ltd.) together with 200 parts of steel beads each having a diameter of 8 mm. Then, the attritor was operated for one hour at a rotational speed of 360 rpm and at 60° C. to obtain a pulverized dry product. 150 parts of this pulverized dry product was introduced into a 3 L kneader together with 1500 parts (5 times of the pigment) of pulverized dry sodium chloride exhibiting a particle size distribution of 20 μm in average particle diameter. While controlling the temperature of heating medium to 60° C., 500 parts of diethylene glycol was added to the kneader and the grinding was initiated. After the grinding of 4 hours, the knead matter was added to water having a volume of 5 times as large as that of the kneaded matter and was agitated, thereby dissolving the sodium chloride and diethylene glycol in water. The resultant solution was then subjected to filtration and to refining, thereby isolating the pigment. The wet cake thus obtained and containing water was subjected to a heating treatment in an oven for 24 hours at 80° C., thereby drying the cake until water content was reduced to less than 1%. Then, the dried cake was pulverized by making use of a hammer mill grinding machine and then filtrated through a 5-mm screen to obtain 120 parts of pigment (Y-3).

The primary particle diameter of the pigment thus obtained is shown in the following Table 2.

TABLE 2

| | | Average primary |
|---|---|---|
| Color | Symbols | particle diameter (nm) |
| GREEN | G-1 | 24.3 |
| YELLOW | Y-1 | 31.2 |
| | Y-2 | 25.2 |
| | Y-3 | 32.0 |

b) Preparation of a Solution of Acrylic Resin

First, 800 g of cyclohexanone was poured into a reaction vessel and then heated to 100° C. while continuing the blowing of nitrogen gas into the reaction vessel. Then, while keeping this temperature, a mixture of the monomers and a thermal polymerization initiator described below was added drop-wise to the cyclohexanone taking one hour, thereby allowing a polymerization reaction to take place.

| | |
|---|---|
| Styrene | 70.0 parts |
| Methacrylic acid | 10.0 parts |
| Methyl methacrylate | 65.0 parts |
| Butyl methacrylate | 65.0 parts |
| Azobis-isobutyronitrile | 10.0 parts |

After finishing the drop-wise addition, the reaction of the resultant mixture was allowed to take place for three hours at 100° C. Then, 2.0 parts of azobis-isobutyronitrile dissolved in 50 parts of cyclohexanone was added to the mixture, thereby allowing the reaction to take place additionally for one hour at 100° C. to synthesize a solution of resin.

After being cooled to room temperature, 2 g of the solution of resin was taken up as a sample and heated to dry for 20 minutes at 180° C. Then, nonvolatile matters was measured and, based on this measurement, cyclohexanone was added appropriately to the previously synthesized solution of resin so as to prepare a solution of acrylic resin containing 20% of nonvolatile matters.

c) Measurement of Birefringence Δn

Samples for measuring birefringence Δn was prepared using pigment dispersions shown in the following Table 3. A retardation Δ(λ) was measured from the direction which was angled by 45° from the direction of the normal to a substrate having a coated film formed thereon by making use of a pigment dispersion shown in the following Table 3. Then, by making use of this value, the three-dimensional refractive index was calculated and, based on this three-dimensional refractive index, a birefringence Δn was calculated according to the following equation.

Namely, pigment dispersions were respectively coated on the surface of glass substrate so as to obtain a coated film having a thickness of 1 μm. Then, the coated film was dried and baked for 30 minutes at 230° C. By making use of a spectroellipsometer (M-220; Nippon Bunkou Co., Ltd.), the n_{XY} and n_{Z} of the coated film were measured. Thereafter, based on the following equation, Δn was calculated. In the cases of green pixel and yellow pixel however, this measurement was performed using a wavelength of 545 nm.

Δn=n_{XY}−n_{Z}

wherein n_{XY} is an average in-plane refractive index and n_{Z} is a refractive index in the thickness-wise direction.

The values thus obtained are shown in the following Table 3.

TABLE 3

| | | Pigment dispersion | | | |
|---|---|---|---|---|---|
| | | G0-1 | Y0-1 | Y0-2 | Y0-3 |
| Pigments | | G-1 | Y-1 | Y-2 | Y-3 |
| Pigment derivatives | | D-3 | D-3 | D-3 | D-3 |
| 1st pigment | | 10.7 | 10.7 | 10.7 | 10.7 |
| Pigment derivatives | | 1.3 | 1.3 | 1.3 | 1.3 |
| Acrylic resin solution | | 40 | 40 | 40 | 40 |
| Organic solvents | | 48 | 48 | 48 | 48 |
| Total | | 100 | 100 | 100 | 100 |
| Δn | | 0.010 | −0.027 | 0.010 | 0.137 |
| C-light source | x | 0.238 | 0.440 | 0.440 | 0.440 |
| | y | 0.600 | 0.514 | 0.510 | 0.456 |
| | Y | 47.792 | 86.899 | 86.579 | 80.357 |

d) Preparation of Pigment Dispersion

The mixtures having the compositions (weight ratio) shown in the following Table 4 were respectively uniformly agitated to form a mixture, which was then subjected to dispersion for 5 hours by means of a sand mill using zirconia beads each having a diameter of 1 mm. The resultant dispersion was then subjected to filtration using a 5-μm filter, thereby obtaining pigment dispersions of various colors.

TABLE 4

| Pigment dispersion | GP-1 | GP-2 | GP-3 | GP-4 | GP-5 | GP-6 | GP-7 | GP-8 | GP-9 | GP-10 | GP-11 | GP-12 | GP-13 |
|---|---|---|---|---|---|---|---|---|---|---|---|---|---|
| 1st pigment | G-1 | G-1 | G-1 | G-1 | G-1 | G-1 | G-1 | G-1 | G-1 | G-1 | G-1 | G-1 | G-1 |
| 2nd pigment | Y-1 | Y-1 | Y-1 | Y-1 | Y-1 | Y-1 | Y-2 | Y-1 | Y-2 | Y-1 | Y-2 | Y-1 | Y-1 |
| 3rd pigment | | Y-2 | Y-2 | Y-2 | Y-2 | | | Y-2 | | Y-2 | | | Y-3 |
| Pigment derivatives 1 | D-3 | D-3 | D-3 | D-3 | D-3 | D-3 | D-3 | D-3 | D-3 | D-3 | D-3 | D-3 | D-3 |
| 1st pigment | 8.1 | 8.1 | 8.1 | 7.1 | 10.3 | 10.4 | 8.1 | 8.1 | 6.2 | 5.9 | 11 | 11.4 | 9.8 |
| 2nd pigment | 5.6 | 2 | 3 | 3.3 | 1.7 | 3.3 | 5.6 | 1 | 0 | 3 | 2.7 | 2.3 | 3.3 |
| 3rd pigment | | 3.6 | 2.6 | 3.3 | 1.7 | | | 4.6 | 7.5 | 4.8 | | | 0.6 |
| Total of pigment derivatives | 1.8 | 1.8 | 1.8 | 1.8 | 1.8 | 1.8 | 1.8 | 1.8 | 1.8 | 1.8 | 1.8 | 1.8 | 1.8 |
| Acrylic resin solution | 36.5 | 36.5 | 36.5 | 36.5 | 36.5 | 36.5 | 36.5 | 36.5 | 36.5 | 36.5 | 36.5 | 36.5 | 36.5 |
| Organic solvents | 48 | 48 | 48 | 48 | 48 | 48 | 48 | 48 | 48 | 48 | 48 | 48 | 48 |
| Total | 100 | 100 | 100 | 100 | 100 | 100 | 100 | 100 | 100 | 100 | 100 | 100 | 100 |

e) Preparation of Photosentive Color Compositions

As shown in the following Table 5, 51 parts of a pigment dispersion RP-1, one part of a solution of acrylic resin, 4 parts of a monomer, 3.4 parts of a photopolymerization initiator, 0.4 parts of a sensitizer and 40.2 parts of an organic solvent were agitated and mixed to obtain an uniform mixture. This mixture was then subjected to filtration using a 5-μm filter, thereby obtaining a color composition GR-1. Color compositions of GR-2-GR-13 were obtained by repeating the same procedures as in the case of the aforementioned GR-1 except that different pigment dispersions described in the following Table 5 were respectively employed.

TABLE 5

| Color composition | GR-1 | GR-2 | GR-3 | GR-4 | GR-5 | GR-6 | GR-7 | GR-8 | GR-9 | GR-10 | GR-11 | GR-12 | GR-13 |
|---|---|---|---|---|---|---|---|---|---|---|---|---|---|
| Pigment dispersion | GP-1 | GP-2 | GP-3 | GP-4 | GP-5 | GP-6 | GP-7 | GP-8 | GP-9 | GP-10 | GP-11 | GP-12 | GP-13 |
| Pigment dispersion | 51 | 51 | 51 | 51 | 51 | 51 | 51 | 51 | 51 | 51 | 51 | 51 | 51 |
| Acrylic resin solution | 1 | 1 | 1 | 1 | 1 | 1 | 1 | 1 | 1 | 1 | 1 | 1 | 1 |
| Monomer | 4 | 4 | 4 | 4 | 4 | 4 | 4 | 4 | 4 | 4 | 4 | 4 | 4 |
| Photopolymerization initiator | 3.4 | 3.4 | 3.4 | 3.4 | 3.4 | 3.4 | 3.4 | 3.4 | 3.4 | 3.4 | 3.4 | 3.4 | 3.4 |
| Sensitizing agent | 0.4 | 0.4 | 0.4 | 0.4 | 0.4 | 0.4 | 0.4 | 0.4 | 0.4 | 0.4 | 0.4 | 0.4 | 0.4 |
| Organic solvents | 40.2 | 40.2 | 40.2 | 40.2 | 40.2 | 40.2 | 40.2 | 40.2 | 40.2 | 40.2 | 40.2 | 40.2 | 40.2 |
| Total | 100 | 100 | 100 | 100 | 100 | 100 | 100 | 100 | 100 | 100 | 100 | 100 | 100 |

f) Retardation in Thickness Direction (Rth)

Coated films each having a different color were manufactured according to the following procedure and the values of retardation in thickness direction were measured.

By means of spin coating, each of green compositions shown in above Table 5 was coated on the surface of a glass substrate and then pre-baked for 20 minutes in a clean oven at 70° C. Then, after being cooled to room temperature, the substrate was exposed to ultraviolet rays by making use of an ultra-high-pressure mercury lamp. Thereafter, the resultant substrate was subjected to spray development by making use of an aqueous solution of sodium carbonate heated to 23° C., after which the resultant substrate was washed with ion-exchange water and air-dried. Subsequently, the resultant substrate was post-baked for 30 minutes in a clean oven at 230° C., thereby forming color layers each formed on the surface of the glass substrate. The film thickness as dried of the cured color layer was 1.8 μm in every case.

The values of retardation in thickness direction were determined as follows. Namely, by making use of a retardation measuring apparatus (RETS-100, Ohtsuka Denshi Co., Ltd.), the retardation Δ(λ) of the coated film was measured from the direction which was angled by 45° from the direction of the normal to the substrate having the coated film formed thereon. Then, by making use of this value, the three-dimensional refractive index was calculated and, based on this three-dimensional refractive index, the value of retardation in thickness direction (Rth) was calculated according to the following equation (2). In this case, a wavelength of 545 nm was used for the measurement of the green pixel.

Rth={(Nx+Ny)/2−Nz}×d (2)

wherein Nx is a refractive index in the direction of x in the plane of color pixel; Ny is a refractive index in the direction of y in the plane of color pixel; and Nz is a refractive index in the thickness-wise direction of color pixel, Nx being defined as a lagging axis represented by Nx≧Ny; and d is a thickness [nm] of color pixel.

The following Table 6 illustrates the values (Rth) of retardation in thickness direction which were obtained employing each of green compositions shown in above Table 5. When it was tried to minimize the color tarnishing of an image in the liquid crystal display device as it is viewed obliquely in the display in the darkened or OFF state in the combination of the value Rth of retardation in thickness direction of the retardation plate and liquid crystal with the value Rth of retardation in thickness direction of the color pixel, the value Rth of retardation in thickness direction of the color pixel was confined to −2≦Rth≦+2.

g) Measurement of Chromaticity

A substrate for measuring the chromaticity was manufactured as described below.

By means of spin-coating method and by variously changing the rotational speed of spin coating, the color compositions GR-1-GR-13 shown in above Table 5 were respectively coated on a glass substrate, thereby manufacturing samples for measuring chromaticity. The samples for measurement were respectively post-baked (curing of film) in a clean oven for 30 minutes at 230° C. The film thickness of the samples after the curing of film was confined within the range of approximately 1.4-2.8 μm. Then, by means of a spectrochromometer (OS2000, Olympus Co., Ltd.), the chromoticity of each of the samples for measurement (coated film of color layer) was measured.

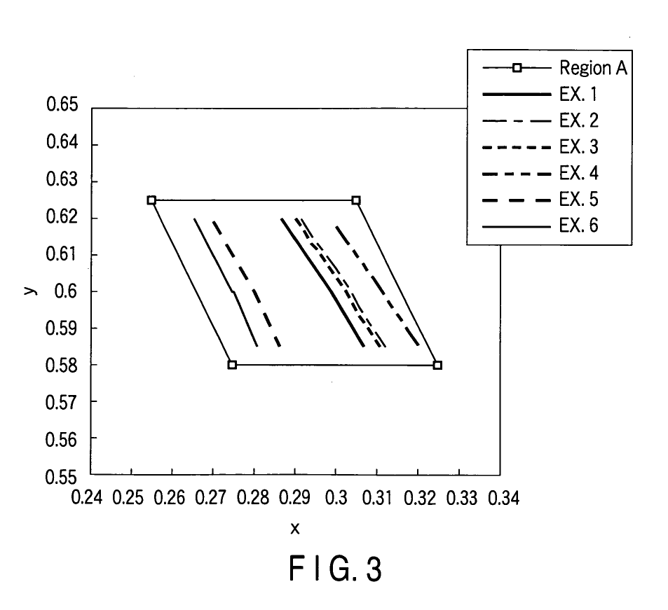

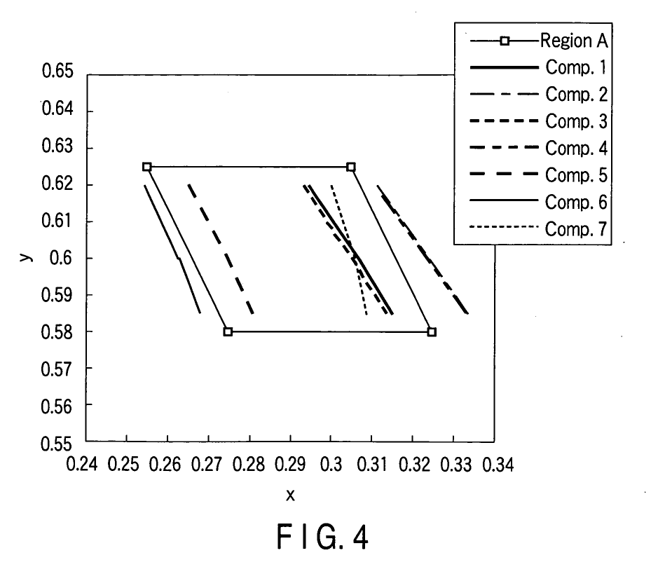

The results of measurement are shown in FIGS. 3 and 4.

By making use of the values of L*, a* and b* which were obtained through the measurement, ΔEab was determined, as shown in the following equation, from the root of the sum of the square of difference in each of these values.

ΔEab=[(ΔL*)²+(Δa*)²+(Δb*)²]^{1/2}

h) Evaluation of Sensitivity

The sensitivity of each of the color compositions shown in above Table 5 was evaluated as described below.

Namely, at first, by means of spin coating, each of the photosensitive compositions thus obtained was coated on the surface of a glass substrate and then prebaked at 70° C. for 15 minutes, thereby forming a coated film having a film thickness of 2.3 μm. Then, by means of a proximity exposure system using ultraviolet rays as an exposure light source, ultraviolet exposure was performed through a photomask provided with a fine line pattern of 50 μm. The dosage of exposure was set to eight levels, i.e., 30, 40, 50, 60, 70, 80, 90 and 100 J/cm².

Then, by making use of a 1.25 mass % sodium carbonate solution, the coated film was shower-developed and then washed with water. The resultant coated film was then heat treated for 20 minutes at 230° C., thus accomplishing the patterning of the coated film.

The film thickness of the color pixel thus obtained was divided by the film thickness (2.3 μm) of the non-exposure/non-development portion, thereby determining the residual film ratio thereof. Then, an exposure sensitivity curve was plotted in a graph with the abscissa representing exposure dosages and the ordinate thereof representing residual film ratios after the development. Based on the exposure sensitivity curve thus obtained, the minimum quantity of exposure which enabled the residual film ratio to keep 80% or more was defined as a saturated exposure dosage. Then, the sensitivity of the color compositions was evaluated according to the following standard.

O: Saturated exposure dosage was no more than 50 J/cm².

□: Saturated exposure dosage was more than 50 J/cm² but no more than 100 J/cm².

X: Saturated exposure dosage was more than 100 J/cm².

Then, by making use of a 1.25-wt % sodium carbonate solution, the coated film was shower-developed and then washed with water. The development time was set to the time which was appropriate in washing out the unexposed coated film. Then, the resultant coated film was heat treated for 20 minutes at 230° C., thus manufacturing the substrates for testing.

i) Evaluation of Contrast

Each of color pixels formed on a transparent substrate was sandwiched between a pair of polarizing plates and a back light was applied to one of the polarizing plates and permitted to emit from the other of the polarizing plates and the luminance of light emitted from said other polarizing plate was measured by means of a luminance meter, thereby determining the luminance of light as these polarizing plates were disposed parallel with each other (Lp) and the luminance of light as these polarizing plates were disposed intersected orthogonally with each other (Lc), after which the ratio between (Lp) and (Lc) was calculated to determine the contrast C(C=Lp/Lc).

CS represents a value of contrast obtained in the case where only the transparent substrate was existed without accompanying the color filter (color layers).

When the contrast ratio between CS and the contrast of each of color layers satisfies the conditions of C/CS>0.45, it is possible to obtain excellent front visibility when displaying the darkened or OFF state image of the liquid crystal display device. Namely, it is possible to reproduce a tight darkened or OFF state display without accompanying leakage of light. On the other hand, if the conditions are not satisfied, the leakage of light would become prominent when displaying the darkened or OFF state image, thus failing to obtain a liquid crystal display device which is excellent in front visibility.

Incidentally, the measurement of contrast was executed by making use of a color luminance meter (for example, BM-5A; Topcon Co., Ltd.). Specifically, under the conditions where only a color layer having a single coated film formed on a transparent substrate or only a transparent substrate is sandwiched between a pair of polarizing plates, the luminance of light (Lp) where these polarizing plates are disposed parallel with each other and the luminance of light (Lc) under a condition wherein these polarizing plates are disposed intersected orthogonally with each other are respectively measured at a viewing angle of 2°, for example. As for the polarizing plate, it is possible to employ NPF-SE1224DU (Nittoh Denko Co., Ltd.). As for the light source for the backlight, it is possible to employ those having characteristics of: luminance=1937 cd/m², a chromaticity coordinate (x, y) in XYZ system of color representation chromaticity diagram is (0.316, 0.301), color temperature=6525K and chromaticity deviation duv=−0.0136.

The results of aforementioned evaluation are shown in the following Table 6.

TABLE 6

| | | | | | | | Comp. | Comp. | Comp. | Comp. | Comp. | Comp. | Comp. |
|---|---|---|---|---|---|---|---|---|---|---|---|---|---|
| | Ex. 1 | Ex. 2 | Ex. 3 | Ex. 4 | Ex. 5 | Ex. 6 | Ex. 1 | Ex. 2 | Ex. 3 | Ex. 4 | Ex. 5 | Ex. 6 | Ex. 7 |
| Color composition | GR-1 | GR-2 | GR-3 | GR-4 | GR-5 | GR-6 | GR-7 | GR-8 | GR-9 | GR-10 | GR-11 | GR-12 | GR-13 |
| Passing | ◯ | ◯ | ◯ | ◯ | ◯ | ◯ | ◯ | ◯ | X | X | ◯ | X | ◯ |
| chromaticity | | | | | | | | | | | | | |
| region A | | | | | | | | | | | | | |
| y = 0.600 [symbol] Y ≧ 57.0 | ◯ | ◯ | ◯ | ◯ | ◯ | ◯ | ◯ | ◯ | ◯ | ◯ | ◯ | X | X |
| Satisfying | −0.0051 | 0.0046 | 0.0019 | 0.0011 | 0.0054 | 0.0011 | 0.0100 | 0.0073 | 0.0100 | 0.0019 | 0.0100 | 0.0037 | 0.0064 |
| formula (1) ◯/ | | | | | | | | | | | | | |
| Not satisfying | ◯ | ◯ | ◯ | ◯ | ◯ | ◯ | X | X | X | ◯ | X | ◯ | X |
| formula (1) X | | | | | | | | | | | | | |
| Rth | −1 | 1 | 0 | 0 | 1 | 0 | 5 | 3 | 5 | 0 | 5 | 0 | 3 |
| C/Cs | 0.46 | 0.62 | 0.53 | 0.53 | 0.55 | 0.5 | 0.51 | 0.5 | 0.47 | 0.46 | 0.55 | 0.5 | 0.35 |
| Sensitivity | ◯ | ◯ | ◯ | ◯ | ◯ | ◯ | ◯ | ◯ | ◯ | ◯ | ◯ | ◯ | ◯ |
| Developing | ◯ | ◯ | ◯ | ◯ | ◯ | ◯ | ◯ | ◯ | ◯ | ◯ | ◯ | ◯ | ◯ |
| property | | | | | | | | | | | | | |

Following facts will be recognized from the above Table 6. Namely, in the cases of Examples 1-6, it will be recognized that since the chromaticity of green pixel was confined within a prescribed range as shown in FIG. 3, it was possible to exhibit excellent green, to enable the luminosity Y of a green pixel to enhance to not less than 57.0 as the chromaticity under the C-light source was set to y=0.600, to reduce the retardation through the satisfaction of the above-described equation (1), to increase the ratio of C/Cs to more than 0.45, and to realize excellent sensitivity and developing properties.

Whereas, in the cases of Comparative Examples 1-3, 5 and 7, although it was possible to realize excellent sensitivity and developing properties, since they did not satisfy the above-described equation (1), the value of retardation became high. Further, in the cases of Comparative Examples 4 and 6, although they satisfied the above-described equation (1) and hence the value of retardation was low, they failed to indicate excellent green due to inappropriate chromaticity thereof falling outside the prescribed range.

What is claimed is:

1. A color filter substrate comprising a transparent substrate, and a plurality of color pixels including a green pixel and formed on the transparent substrate, wherein the green pixel contains halogenated zinc phthalocyanine-based green pigment and at least one kind of yellow pigment and satisfies three conditions (a), (b) and (c) described below, and absolute value of retardation in thickness direction (Rth) of the green pixel which is represented by the following equation (2) is confined to no more than 2 nm.
(a) Chromaticity (x, y) based on the C-light source of the green pixel is regulated so as to fall within a region encircled by straight lines connecting four points of: (0.255, 0.625), (0.275, 0.580), (0.325, 0.580) and (0.305, 0.625);
(b) When chromaticity of the green pixel based on C-light source is set to y=0.600, luminosity Y is not less than 57.0; and
(c) Absolute value of a sum of products of a birefringence of each of pigments (A, B, - - - ) constituting the green pixel and weight ratio of each of pigments satisfies following formula (1):

|{(Δn of pigment A)×(weight ratio of pigment A)}+{(Δn of pigment B)×(weight ratio of pigment B)}+ - - - |≦0.006 (1):
wherein Δn is a birefringence obtained by subtracting refractive index in thickness direction n_{Z} of a color film formed of a pigment sample from average in-plane refractive index n_{XY} of a color film formed of a pigment sample.
Rth={(Nx+Ny)/2−Nz}×d (2)
wherein Nx is a refractive index in x-direction in a plane of the green pixel; Ny is a refractive index in y-direction in a plane of the green pixel; Nz is a refractive index in thickness direction of the green pixel, Nx being defined as a slow axis represented by Nx≧Ny; and d is a thickness [nm] of the green pixel.

2. The color filter substrate according to claim 1, wherein the green pixel contains a plurality of yellow pigments each having a color difference ΔEab of no more than 3.

3. The color filter substrate according to claim 1, wherein the green pixel at least contains two kinds of yellow pigments represented by C.I. Pigment Yellow 138 yellow pigment and C.I. Pigment Yellow 150 yellow pigment.

4. The color filter substrate according to claim 1, wherein a particle size distribution of primary particles of pigment contained in each of a plurality of color pixels is confined to no more than 40 nm in terms of particle diameter d50 which corresponds to 50% of a total of integrated quantity in a cumulative curve of number particle size distribution.

5. The color filter substrate according to claim 1, which further comprises a black matrix formed on the transparent substrate, and said plurality of color pixels include a red pixel, a green pixel and a blue pixel, all of the color pixels being formed respectively in regions partitioned by the black matrix.

6. A liquid crystal display device which is provided with the color filter substrate according to claim 1.
